(19) United States
(12) Patent Application Publication
(10) Pub. No.: US 2025/0004991 A1
(43) Pub. Date: Jan. 2, 2025

(54) BLOCK-LEVEL, BIT-MAPPED BINARY DATA ACCESS FOR PARALLEL PROCESSING

(71) Applicant: CenturyLink Intellectual Property LLC, Denver, CO (US)

(72) Inventors: Dean Ballew, Sterling, VA (US); John R. B. Woodworth, Amissville, VA (US); Frank Moss, Chesterfield, MO (US); Kevin M. McBride, Lone Tree, CO (US); Brian J. Strong, St. Louis, MO (US)

(73) Assignee: CenturyLink Intellectual Property LLC, Denver, CO (US)

(21) Appl. No.: 18/756,625

(22) Filed: Jun. 27, 2024

Related U.S. Application Data
(60) Provisional application No. 63/511,378, filed on Jun. 30, 2023.

(51) Int. Cl. G06F 16/174; G06F 16/13

(52) U.S. Cl. CPC G06F 16/1744; G06F 16/13

(57) ABSTRACT

Novel tools and techniques are provided for implementing block-level, bit-mapped binary data access for parallel processing. In various embodiments, a computing system may cause a plurality of compute nodes to perform one or more tasks (e.g., artificial intelligence (“AI”) and/or machine learning (“ML”) tasks) on portions of decompressed data, after causing some, but not all, of the compute nodes to decompress the entire compressed data. In some cases, the computing system may cause each compute node to decompress portions of the compressed data. Once the data has been decompressed and/or bit-mapped, each compute node may be caused to perform at least one task (e.g., AI/ML task) on its assigned portion of the decompressed data. Different portions of the same decompressed data may be processed with the same (AI/ML) algorithm, or the same portions of the same decompressed data may be processed with a different (AI/ML) algorithm, or a combination thereof.

### CROSS-REFERENCE TO RELATED APPLICATIONS

This application claims the benefit of U.S. Provisional Application No. 63/511,378 filed Jun. 30, 2023, entitled “Block-Level, Bit-Mapped Binary Data Access for Parallel Processing,” which is incorporated herein by reference in its entirety.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, systems, and apparatuses for implementing data access provisioning for parallel processing, and, more particularly, to methods, systems, and apparatuses for implementing block-level, bit-mapped binary data access for parallel processing, in some cases, using artificial intelligence (“AI”) and/or machine learning (“ML”) algorithms on media content data (e.g., video data, image data, audio data, streaming data, and/or the like).

### BACKGROUND

Conventionally, complicated tasks, such as machine learning (“ML”) analytics, on binary data can be processed in parallel, but it comes at a processing performance penalty, particularly when compressible data is used. For example, if a large image is processed in parallel, the image must be copied to and decompressed in-memory by every node involved, thus utilizing resources of every node for decompression of the entire image. It is with respect to this general technical environment to which aspects of the present disclosure are directed.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components. For denoting a plurality of components, the suffixes “a” through “n” may be used, where n denotes any suitable integer number (unless it denotes the number 14, if there are components with reference numerals having suffixes “a” through “m” preceding the component with the reference numeral having a suffix “n”), and may be either the same or different from the suffix “n” for other components in the same or different figures. For example, for component #1 X05a-X05n, the integer value of n in X05n may be the same or different from the integer value of n in X10n for component #2 X10a-X10n, and so on.

FIG. 1 is a schematic diagram illustrating a system for implementing block-level, bit-mapped binary data access for parallel processing, in accordance with various embodiments.

FIGS. 2A and 2B are schematic diagrams illustrating a set of non-limiting examples of a process flow for implementing block-level, bit-mapped binary data access for parallel processing, in accordance with various embodiments.

FIGS. 3A and 3B are schematic diagrams illustrating another set of non-limiting examples of a process flow for implementing block-level, bit-mapped binary data access for parallel processing, in accordance with various embodiments.

FIGS. 4A and 4B are flow diagrams illustrating various methods for implementing block-level, bit-mapped binary data access for parallel processing, in accordance with various embodiments.

FIG. 5 is a block diagram illustrating an exemplary computer or system hardware architecture, in accordance with various embodiments.

### DETAILED DESCRIPTION OF CERTAIN EMBODIMENTS

### Overview

Various embodiments provide tools and techniques for implementing data access provisioning for parallel processing, and, more particularly, to methods, systems, and apparatuses for implementing block-level, bit-mapped binary data access for parallel processing.

In various embodiments, a compute node among a plurality of compute nodes may receive one or more first instructions to perform one or more tasks, such as AI/ML tasks, on an assigned portion of first data. Based on a determination that the one or more first instructions include second instructions to decompress the first data, the first data being compressed first data, the compute node may perform the following: accessing the compressed first data; decompressing the compressed first data; and storing the decompressed first data in a first data storage location. In some cases, the compute node may send a message regarding the decompressed first data being stored in the first data storage location. Based on a determination that the one or more first instructions include third instructions regarding how to access the assigned portion of the first data, the first data being the decompressed first data, the compute node may retrieve the assigned portion of the decompressed first data, based on the third instructions. In some instances, the third instructions may further include instructions on how to calculate a start of the assigned portion of the first decompressed data, and, prior to retrieving the assigned portion of the decompressed first data, the compute node may calculate the start of the assigned portion of the first decompressed data, based on the third instructions and based on the calculated start of the assigned portion of the first decompressed data. In the case that the one or more first instructions do not include instructions regarding how to access the assigned portion of the first data, the compute node may retrieve the assigned portion of the decompressed first data, in some cases, based on established or existing protocols or procedures of its file system agent, or the like. The compute node may perform at least one (AI/ML) task among the one or more (AI/ML) tasks on the assigned portion of the decompressed first data; and may send results of the at least one (AI/ML) task.

In some aspects, a computing system (a) may receive, from a requesting device, a request to perform one or more (AI/ML) tasks on first data; (b) in response to receiving the request to perform the one or more (AI/ML) tasks on first data, may identify a first plurality of compute nodes among a plurality of compute nodes that is available to concurrently perform (and capable of concurrently performing) the one or more (AI/ML) tasks on portions of the first data, the first data being compressed data; (c) may identify or select one or more first compute nodes among the first plurality of compute nodes to perform decompression of the first data; (d) may send, to each of the one or more first compute nodes, one or more first instructions to decompress the first data and to perform at least one first (AI/ML) task among the one or more (AI/ML) tasks on a portion of the decompressed first data; (e) may receive, from each of the one or more first compute nodes, a message regarding a data storage location in which the decompressed first data is being stored; (f) may send, to each of one or more second compute nodes among the first plurality of compute nodes, one or more second instructions to perform at least one second (AI/ML) task among the one or more (AI/ML) tasks on an assigned portion of the decompressed first data, the one or more second instructions including third instructions regarding how to access the assigned portion of the decompressed first data; (g) may receive, from each of the one or more first compute nodes and from each of the one or more second compute nodes, results of one of the at least one first (AI/ML) tasks or the at least one second (AI/ML) tasks; (h) may collate or compile the received results; and (i) may send the collated or compiled results to the requesting device. In some cases, the third instructions may further include instructions on how to calculate a start of the assigned portion of the first decompressed data.

The various embodiments leverage mechanisms in file systems (or file system services) that: (1) decompress known binary filetypes (including, but not limited to, video: H.264 (MPEG-4), H.265 (HEVC), etc.; image: JPG, HEIF, etc.; audio: ACC, MP3, etc.; and the like) as bit-mapped binary data at the device level; and (2) service participating nodes with block-level bit-mapped binary access. This can be integrated into the file system or performed via a file system agent(s). The binary decompression/extraction can also lead to: (a) faster seeks and more efficient transfers due to predictable (fixed) data locations; (b) less overall memory usage due to applications not requiring independent in-memory decompression; (c) shared memory pointers (new API's, RPC's, etc.); (d) parallel processing, by individual nodes, of (i) different portions of the same bit-mapped binary file with the same algorithm-set, (ii) the same portions of the same bit-mapped binary file with a different algorithm-set, or (iii) various combinations of these processes; (e) advances in filesystem and storage services; and/or (f) the expanded block-level transfer of bit-mapped data remaining on a single node (or storage device) or being distributed across multiple nodes (or storage devices); and/or the like.

These and other aspects of the block-level, bit-mapped binary data access for parallel processing are described in greater detail with respect to the figures.

The following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

In an aspect, a method may comprise receiving, by a compute node among a plurality of compute nodes, one or more first instructions to perform one or more tasks on an assigned portion of first data. The method may further comprise, based on a determination that the one or more first instructions include second instructions to decompress the first data, the first data being compressed first data, performing the following: accessing, by the compute node, the compressed first data; decompressing, by the compute node, the compressed first data; and storing, by the compute node, the decompressed first data in a first data storage location. The method may also comprise, based on a determination that the one or more first instructions include third instructions regarding how to access the assigned portion of the first data, the first data being the decompressed first data, performing the following: retrieving, by the compute node, the assigned portion of the decompressed first data, based on the third instructions. The method may further comprise performing, by the compute node, at least one task among the one or more tasks on the assigned portion of the decompressed first data; and sending, by the compute node, results of the at least one task.

According to some embodiments, the first data may comprise one of a data file or streaming data, or the like. In some cases, the first data may be of a data type comprising one of video data, two-dimensional (“2D”) image data, three-dimensional (“3D”) image data, animation data, gaming content data, or audio data, and/or the like.

In some embodiments, the one or more first instructions may be received from a computing system. In some examples, the computing system may comprise at least one of an orchestration system, a task distribution system, a task manager, a server, an artificial intelligence (“AI”) and/or machine learning (“ML”) system, a cloud computing system, or a distributed computing system, and/or the like. Although, in examples, aspects of the present systems and methods are disclosed as comprising AI/ML systems performing AI/ML tasks, it will be apparent to those of skill in the art that the present systems are not limited to such and may be applied to other computing systems performing other computing tasks in the manner disclosed.

In some instances, accessing the compressed first data may comprise one of: receiving, by the compute node, the compressed first data from the computing system, the compressed first data being sent by the computing system as one of part of the one or more first instructions, part of a separate message after sending the one or more first instructions, or part of a reply message in response to a query by the compute node; retrieving, by the compute node, the compressed first data from a data source, wherein the data source may comprise at least one of a file system server, a multimedia database, a shared database, or a cloud database, and/or the like; retrieving, by the compute node, the compressed first data from at least one other compute node among the plurality of compute nodes; accessing, by the compute node, the compressed first data from one of the data source or the at least one other compute node, via an application programming interface (“API”); or accessing, by the compute node, the compressed first data from one of the data source or the at least one other compute node, via a remote procedure call (“RPC”); or the like.

In some cases, decompressing the compressed first data may comprise one of: decompressing, by the compute node, an entirety of the compressed first data; or performing the following: receiving, by the compute node, a state of decompression from at least one of the computing system or one other compute node among the plurality of compute nodes, the one or more first instructions being sent by the at least one of the computing system or the one other compute node; decompressing, by the compute node, the assigned portion of the compressed first data, based on at least one of the state of decompression or the one or more first instructions; determining, by the compute node, an updated state of decompression after decompressing the assigned portion of the compressed first data; and sending, by the compute node, the updated state of decompression to at least one of the computing system or one or more other compute nodes among the plurality of compute nodes; or the like. In some examples, decompressing the compressed first data may further comprise generating, by the compute node, bit-mapped binary data, and retrieving the assigned portion of the decompressed first data may comprise accessing one or more blocks of the bit-mapped binary data corresponding to the assigned portion of the decompressed first data.

In some instances, storing the decompressed first data in the first data storage location may comprise storing, by a file system agent of the compute node, the decompressed first data in the first data storage location; and sending, by the compute node, a message regarding the decompressed first data being stored in the first data storage location. In some cases, the first data storage location may comprise one of a data storage location of a local disk storage device, a data storage location of a file system server, a data storage location of the file system agent of the compute node, or a data storage location of each of one or more other compute nodes among the plurality of compute nodes, and/or the like. In some examples, sending the message regarding the decompressed first data being stored in the first data storage location may comprise one of: sending, by the compute node and to the computing system, the message regarding the decompressed first data being stored in the first data storage location; sending, by the compute node and to each of the one or more other compute nodes, the message regarding the decompressed first data being stored in the first data storage location; or publishing, by the compute node, the message regarding the decompressed first data being stored in the first data storage location; and/or the like.

According to some embodiments, retrieving the assigned portion of the decompressed first data may comprise one of: retrieving, by a file system agent of the compute node, the assigned portion of the decompressed first data from a data storage location of a local disk storage device; retrieving, by the file system agent of the compute node, the assigned portion of the decompressed first data from a data storage location of a file system server; or retrieving, by the file system agent of the compute node, the assigned portion of the decompressed first data from a data storage location of the file system agent of the compute node; or the like. In some instances, the third instructions may further comprise instructions on how to calculate a start of the assigned portion of the first decompressed data, and the method may further comprise, prior to retrieving the assigned portion of the decompressed first data, calculating, by the compute node, the start of the assigned portion of the first decompressed data, based on the third instructions. In some cases, retrieving the assigned portion of the decompressed first data may comprise retrieving, by the compute node, the assigned portion of the decompressed first data, without retrieving non-assigned portions of the decompressed first data, the non-assigned portions of the decompressed first data being assigned to one or more other compute nodes among the plurality of compute nodes.

In some embodiments, the one or more tasks may comprise one or more artificial intelligence (“AI”) and/or machine learning (“ML”) tasks, and the one or more AI/ML tasks may comprise at least one of: detecting or identifying an image of at least one object contained in the first data, using one or more AI/ML algorithms, the at least one object comprising at least one of one or more people, one or more animals, one or more plants, one or more natural formations, one or more structures, one or more devices, one or more vehicles, or one or more constructs, and/or the like; performing identity recognition or authentication of at least one person, based on biometric data of the at least one person contained in the first data, using one or more AI/ML algorithms; analyzing or recognizing features of maps contained in the first data, using one or more AI/ML algorithms; analyzing or recognizing features of satellite imagery contained in the first data, using one or more AI/ML algorithms; analyzing or recognizing features of stellar imagery contained in the first data, using one or more AI/ML algorithms; analyzing or decoding data contained in the first data, using one or more AI/ML algorithms; performing pattern recognition, using one or more AI/ML algorithms; or training one or more AI/ML algorithms; and/or the like.

In another aspect, a method may comprise, in response to receiving, from a requesting device, a request to perform one or more tasks on first data, identifying, by a computing system, a first plurality of compute nodes that is available to concurrently perform the one or more tasks on portions of the first data, the first data being compressed data; identifying or selecting, by the computing system, one or more first compute nodes among the first plurality of compute nodes to perform decompression of the first data; sending, by the computing system and to each of the one or more first compute nodes, one or more first instructions to decompress the first data and to perform at least one first task among the one or more tasks on a portion of the decompressed first data; receiving, by the computing system and from each of the one or more first compute nodes, a message regarding a data storage location in which the decompressed first data is being stored; sending, by the computing system and to each of one or more second compute nodes among the first plurality of compute nodes, one or more second instructions to perform at least one second task among the one or more tasks on an assigned portion of the decompressed first data, the one or more second instructions including third instructions regarding how to access the assigned portion of the decompressed first data; receiving, by the computing system and from each of the one or more first compute nodes and from each of the one or more second compute nodes, results of one of the at least one first tasks or the at least one second tasks; collating or compiling, by the computing system, the received results; and sending, by the computing system, the collated or compiled results to the requesting device.

In some embodiments, the computing system may comprise at least one of an orchestration system, a task distribution system, a task manager, a server, an artificial intelligence (“AI”) and/or machine learning (“ML”) system, a cloud computing system, or a distributed computing system, and/or the like. In some instances, the first data may comprise one of a data file or streaming data, or the like. In some cases, the first data may be of a data type comprising one of video data, two-dimensional (“2D”) image data, three-dimensional (“3D”) image data, animation data, gaming content data, or audio data, and/or the like.

According to some embodiments, the decompressed first data may be divided among a number of compute nodes comprising the one or more first compute nodes and the one or more second compute nodes. In some cases, the at least one second tasks may be the same as the at least one first tasks, and each of the number of compute nodes may perform the at least one first or second tasks on its assigned portion of the decompressed first data.

In some examples, the one or more first compute nodes may comprise two or more compute nodes each providing the decompressed first data to one of two or more groups of compute nodes. In some instances, the one or more second compute nodes may be divided among the two or more groups of compute nodes, and each group of compute nodes may perform at least one tasks among the one or more tasks that is different from tasks performed by other groups of compute nodes.

In some embodiments, the one or more first instructions to decompress the first data may comprise one of: fourth instructions to decompress an entirety of the compressed first data; or fifth instructions to decompress the portion of the decompressed first data, based on a state of decompression from at least one of the computing system or one other compute node among the first plurality of compute nodes, and to send an updated state of decompression to at least one of the computing system or one or more other compute nodes among the plurality of compute nodes, after decompressing the portion of the compressed first data; or the like.

In some cases, the third instructions may further comprise instructions on how to calculate a start of the assigned portion of the first decompressed data.

In yet another aspect, a system may comprise a plurality of compute nodes and a computing system. The computing system may comprise at least one first processor and a first non-transitory computer readable medium communicatively coupled to the at least one first processor. The first non-transitory computer readable medium may have stored thereon computer software comprising a first set of instructions that, when executed by the at least one first processor, causes the computing system to: in response to receiving, from a requesting device, a request to perform one or more artificial intelligence (“AI”) and/or machine learning (“ML”) tasks on first data, identify a first plurality of compute nodes among the plurality of compute nodes that is available to concurrently perform the one or more AI/ML tasks on portions of the first data, the first data being compressed data; identify or select one or more first compute nodes among the first plurality of compute nodes to perform decompression of the first data; send, to each of the one or more first compute nodes, one or more first instructions to decompress the first data and to perform at least one first AI/ML task among the one or more AI/ML tasks on a portion of the decompressed first data; receive, from each of the one or more first compute nodes, a message regarding a data storage location in which the decompressed first data is being stored; send, to each of one or more second compute nodes among the first plurality of compute nodes, one or more second instructions to perform at least one second AI/ML task among the one or more AI/ML tasks on an assigned portion of the decompressed first data, the one or more second instructions including third instructions regarding how to access the assigned portion of the decompressed first data; receive, from each of the one or more first compute nodes and from each of the one or more second compute nodes, results of one of the at least one first AI/ML tasks or the at least one second AI/ML tasks; collate or compile the received results; and send the collated or compiled results to the requesting device.

Various modifications and additions can be made to the embodiments discussed without departing from the scope of the invention. For example, while the embodiments described above refer to particular features, the scope of this invention also includes embodiments having different combination of features and embodiments that do not include all of the above-described features.

### Specific Exemplary Embodiments

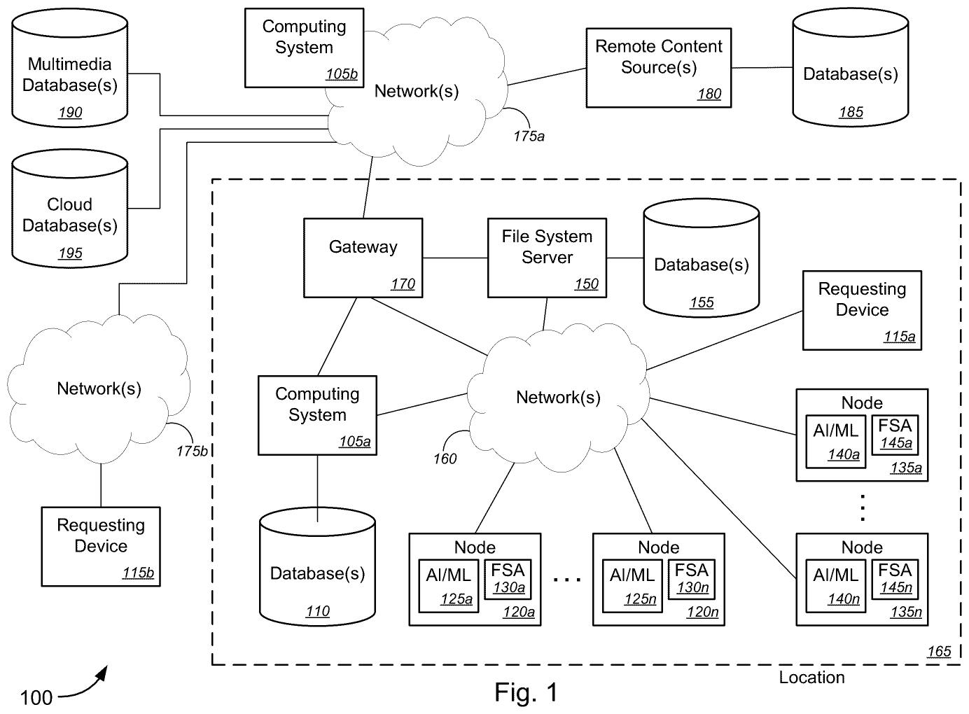

We now turn to the embodiments as illustrated by the drawings. FIGS. 1-5 illustrate some of the features of the method, system, and apparatus for implementing data access provisioning for parallel processing, and, more particularly, to methods, systems, and apparatuses for implementing block-level, bit-mapped binary data access for parallel processing, as referred to above. The methods, systems, and apparatuses illustrated by FIGS. 1-5 refer to examples of different embodiments that include various components and steps, which can be considered alternatives or which can be used in conjunction with one another in the various embodiments. The description of the illustrated methods, systems, and apparatuses shown in FIGS. 1-5 is provided for purposes of illustration and should not be considered to limit the scope of the different embodiments.

With reference to the figures, FIG. 1 is a schematic diagram illustrating a system 100 for implementing block-level, bit-mapped binary data access for parallel processing, in accordance with various embodiments.

In the non-limiting embodiment of FIG. 1, system 100 may include computing system 105a and corresponding database(s) 110, a requesting device 115a, a plurality of compute nodes 120a-120n and/or 135a-135n (collectively, “compute nodes,” “nodes,” “compute nodes 120,” “nodes 120,” “compute nodes 135,” or “nodes 135,” or the like), and file system server 150 and corresponding database(s) 155. In some instances, each node 120 may include, without limitation, at least one of (a) artificial intelligence (“AI”) and/or machine learning (“ML”) system 125 among AI/ML systems 125a-125n across all nodes 120a-120n and (b) a file system agent (“FSA”) 130 among FSAs 130a-130n also across all nodes 120a-120n, or the like. Similarly, in some cases, each node 120 may include, without limitation, at least one of (a) AI/ML system 140 among AI/ML systems 140a-140n across all nodes 135a-135n and (b) a file system agent FSA 145 among FSAs 145a-145n also across all nodes 135a-135n, or the like. In some examples, each AI/ML system 125 or 140 may utilize AI/ML models and algorithms. In some instances, file system server 150 (also referred to as a “file server” or a “fileserver”) may perform at least one of accessing, retrieving, storing, and/or providing a location of data stored within a storage device for shared disk access (i.e., location from which devices that share access to the storage device can access the data), or the like, and may serve devices within a local network(s) 160 and/or a location 165. In some cases, each FSA 130 or 145 may function in a similar manner as the file system server 150, but may be configured to serve the node 120 or 135 on which it is hosted.

In some embodiments, system 100 may further include gateway device 170. In some examples, computing system 105a, database(s) 110, requesting device 115a, nodes 120a-120n and/or 135a-135n, file system server 150, database(s) 155, network(s) 160, and gateway device 170 may be located or disposed within location 165. According to some embodiments, system 100 may further include at least one of computing system 105b, requesting device 115b, network(s) 175a and/or 175b, remote content source(s) 180 and corresponding database(s) 185, multimedia database(s) 190, and cloud database(s) 195, each of which may be located or disposed external to location 165.

In some examples, the computing system 105a may include, without limitation, at least one of an orchestration system, a task distribution system, a task manager, a server, or an artificial intelligence (“AI”) and/or machine learning (“ML”) system, and/or the like. Herein, “AI/ML system” may refer to a system that is configured to perform one or more artificial intelligence functions, including, but not limited to, machine learning functions, deep learning functions, neural network functions, expert system functions, and/or the like. Herein also, tasks performed by an AI/ML system, in some cases, using one or more AI/ML algorithms, may be referred to as “AI/ML tasks,” which may refer to one or more artificial intelligence tasks including, but not limited to, machine learning tasks, deep learning tasks, neural network tasks, expert system tasks, and/or the like, while “AI/ML algorithms” may refer to one or more artificial intelligence algorithms including, but not limited to, machine learning algorithms, deep learning (“DL”) algorithms, neural network (“NN”) algorithms, expert system (“ES”) algorithms, and/or the like. By contrast, non-AI/ML tasks may refer to any tasks that are performed by a computing system without using any artificial intelligence algorithms. Herein, tasks without specific reference to either AI/ML tasks or non-AI/ML tasks may refer to either or both.

In some cases, computing system 105b may include, but is not limited to, at least one of an orchestration system, a task distribution system, a task manager, a server, an AI/ML system, a cloud computing system, or a distributed computing system, and/or the like. In some instances, the requesting device 115a and/or 115b may each include, but is not limited to, one of a desktop computer, a laptop computer, a tablet computer, a smart phone, a mobile phone, a network operations center (“NOC”) computing system or console, or any suitable device capable of communicating with computing system 105a and/or 105b via network(s) 160, 175a, and/or 175b, or via any suitable device capable of communicating with at least one of computing system(s) 105a and/or 105b, via a web-based portal, an application programming interface (“API”), a server, a software application (“app”), or any other suitable communications interface, or the like (not shown), over network(s) 160, 175a, and/or 175b. In some cases, location 165 may include, but is not limited to, one of a data center, a cloud computing facility, a service provider facility, a business customer premises, a corporate customer premises, an enterprise customer premises, an education facility customer premises, a medical facility customer premises, or a governmental customer premises, and/or the like.

According to some embodiments, network(s) 160, 175a, and/or 175b may each include, without limitation, one of a local area network (“LAN”), including, without limitation, a fiber network, an Ethernet network, a Token-Ring™ network, and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including, without limitation, a network operating under any of the IEEE 802.11 suite of protocols, the Bluetooth™ protocol known in the art, and/or any other wireless protocol; and/or any combination of these and/or other networks. In a particular embodiment, the network(s) 160, 175a, and/or 175b may include an access network of the service provider (e.g., an Internet service provider (“ISP”)). In another embodiment, the network(s) 160, 175a, and/or 175b include a core network of the service provider and/or the Internet.

In operation, a compute node among a plurality of compute nodes (e.g., compute nodes 120a-120n and/or 135a-135n, or the like) may receive one or more first instructions to perform one or more tasks on an assigned portion of first data. Based on a determination that the one or more first instructions include second instructions to decompress the first data, the first data being compressed first data, the compute node may perform the following: accessing the compressed first data (e.g., from a source(s) of compressed data, including, but not limited to, one or more of computing system 105a or 105b, database(s) 110, file system server 150, database(s) 155, remote content source(s) 180, database(s) 185, multimedia database(s) 190, and/or cloud database(s) 195, or the like); decompressing the compressed first data; and storing the decompressed first data in a first data storage location (e.g., one or more of FSAs 130a-130n and/or 145a-145n, file system server 150, and/or database(s) 155, or the like). In some instances, the compute node may store the decompressed first data in the first data storage location, by using its FSA (e.g., one of FSAs 130a-130n and/or 145a-145n, or the like), the decompressed first data in the first data storage location. In some cases, the compute node may send a message regarding the decompressed first data being stored in the first data storage location.

Based on a determination that the one or more first instructions include third instructions regarding how to access the assigned portion of the first data, the first data being the decompressed first data, the compute node may retrieve the assigned portion of the decompressed first data, based on the third instructions. In some instances, the third instructions may further include instructions on how to calculate a start of the assigned portion of the first decompressed data, and, prior to retrieving the assigned portion of the decompressed first data, the compute node may calculate the start of the assigned portion of the first decompressed data, based on the third instructions and based on the calculated start of the assigned portion of the first decompressed data. In the case that the one or more first instructions do not include instructions regarding how to access the assigned portion of the first data, the compute node may retrieve the assigned portion of the decompressed first data, in some cases, based on established or existing protocols or procedures of its FSA, or the like.

In some cases, the compute node may perform at least one task among the one or more tasks on the assigned portion of the decompressed first data; and may send results of the at least one task. In examples in which the one or more tasks include one or more AI/ML tasks, the compute node may perform, using its AI/ML system (e.g., one of AI/ML system 125a-125n or 140a-140n, or the like), at least one AI/ML task among the one or more AI/ML tasks on the assigned portion of the decompressed first data; and may send results of the at least one AI/ML task. As described above, tasks performed by an AI/ML system are referred to as AI/ML tasks, which may include any tasks in which artificial intelligence algorithms (including, but not limited to, ML algorithms, DL algorithms, NN algorithms, and/or ES algorithms, etc.) are used.

In some embodiments, the one or more first instructions may be received from a computing system (e.g., computing system 105a or 105b, or the like). In such cases, sending the results may include sending the results to the computing system from which it received the one or more first instructions. According to some embodiments, the first data may include one of a data file or streaming data, or the like. In some cases, the first data may be of a data type including, but not limited to, one of video data (e.g., video data in file formats including advanced video coding (“AVC”) (or H.264 or moving picture experts group-4 (“MPEG-4”)) format, high efficiency video coding (“HEVC”) (or H.265 or MPEG-H) format, audio video interleave (“AVI”) format, advanced systems format (“ASF”), etc.), two-dimensional (“2D”) image data (e.g., 2D image data in file formats including joint photographic experts group (“JPG”) format, graphics interchange format (“GIF”), portable network graphic (“PNG”) format, high efficiency image format (“HEIF”), etc.), three-dimensional (“3D”) image data (e.g., 3D image data in file formats including DWG format, STL format, OBJ format, 3D manufacturing format (“3MF”), etc.), animation data (e.g., animation data in file formats including GIF, PNG format, scalable vector graphics animation (“SVG”) format, etc.), gaming content data (e.g., gaming content data in file formats including PNG format, JPG format, GIF, SVG, etc.), or audio data (e.g., audio data in file formats including pulse-code modulation (“PCM”) format, waveform audio file (“WAV”) format, audio interchange file format (“AIFF”), MPEG-1 audio layer 3 (“MP3”) format, advanced audio coding (“ACC”) format, etc.), and/or the like.

In some embodiments, the one or more AI/ML tasks may include, without limitation, at least one of: (A) detecting or identifying an image of at least one object contained in the first data, using one or more AI/ML algorithms, the at least one object including, but not limited to, at least one of one or more people, one or more animals, one or more plants, one or more natural formations, one or more structures, one or more devices, one or more vehicles, or one or more constructs, and/or the like; (B) performing identity recognition or authentication of at least one person, based on biometric data of the at least one person contained in the first data, using one or more AI/ML algorithms; (C) analyzing or recognizing features of maps contained in the first data, using one or more AI/ML algorithms; (D) analyzing or recognizing features of satellite imagery contained in the first data, using one or more AI/ML algorithms; (E) analyzing or recognizing features of stellar imagery contained in the first data, using one or more AI/ML algorithms; (F) analyzing or decoding data contained in the first data, using one or more AI/ML algorithms; (G) performing pattern recognition, using one or more AI/ML algorithms; or (H) training one or more AI/ML algorithms; and/or the like. In some cases, the one or more AI/ML algorithms for performing each of these tasks may be the same for two or more of these tasks or, in some instances, may be the same for all of these tasks. In other cases, the one or more AI/ML algorithms may be different for each of these tasks.

In some examples, decompressing the compressed first data may further include the compute node generating bit-mapped binary data. In some instances, retrieving the assigned portion of the decompressed first data may further include the compute node accessing one or more blocks of the bit-mapped binary data corresponding to the assigned portion of the decompressed first data.

In an aspect, computing system 105a and/or computing system 105b (collectively, “computing system” or the like) (a) may receive, from a requesting device (e.g., requesting device 115a or 115b, or the like), a request to perform one or more AI/ML tasks on first data; (b) in response to receiving the request to perform the one or more AI/ML tasks on first data, may identify a first plurality of compute nodes among a plurality of compute nodes (e.g., nodes 120a-120n and/or 135a-135n, or the like) that is available to concurrently perform (and capable of concurrently performing) the one or more AI/ML tasks on portions of the first data, the first data being compressed data; (c) may identify or select one or more first compute nodes among the first plurality of compute nodes to perform decompression of the first data; (d) may send, to each of the one or more first compute nodes, one or more first instructions to decompress the first data and to perform at least one first AI/ML task among the one or more AI/ML tasks (e.g., using its AI/ML system 125 or 140, or the like) on a portion of the decompressed first data; (c) may receive, from each of the one or more first compute nodes, a message regarding a data storage location in which the decompressed first data is being stored (e.g., one or more of FSAs 130a-130n and/or 145a-145n, file system server 150, and/or database(s) 155, or the like); (f) may send, to each of one or more second compute nodes among the first plurality of compute nodes, one or more second instructions to perform at least one second AI/ML task among the one or more AI/ML tasks (e.g., using its AI/ML system 125 or 140, or the like) on an assigned portion of the decompressed first data, the one or more second instructions including third instructions regarding how to access the assigned portion of the decompressed first data; (g) may receive, from each of the one or more first compute nodes and from each of the one or more second compute nodes, results of one of the at least one first AI/ML tasks or the at least one second AI/ML tasks; (h) may collate or compile the received results; and (i) may send the collated or compiled results to the requesting device. In some cases, the third instructions may further include instructions on how to calculate a start of the assigned portion of the first decompressed data.

According to some embodiments, the decompressed first data may be divided among a number of compute nodes including the one or more first compute nodes and the one or more second compute nodes. In some cases, the at least one second AI/ML tasks may be the same as the at least one first AI/ML tasks, and each of the number of compute nodes may perform the at least one first or second AI/ML tasks on its assigned portion of the decompressed first data.

In some examples, the one or more first compute nodes may include two or more compute nodes each providing the decompressed first data to one of two or more groups of compute nodes. In some instances, the one or more second compute nodes may be divided among the two or more groups of compute nodes, and each group of compute nodes may perform at least one AI/ML tasks among the one or more AI/ML tasks that is different from AI/ML tasks performed by other groups of compute nodes.

In some embodiments, the one or more first instructions to decompress the first data may include one of: fourth instructions to decompress an entirety of the compressed first data; or fifth instructions to decompress the portion of the decompressed first data, based on a state of decompression from at least one of the computing system or one other compute node among the first plurality of compute nodes, and to send an updated state of decompression to at least one of the computing system or one or more other compute nodes among the plurality of compute nodes, after decompressing the portion of the compressed first data; or the like.

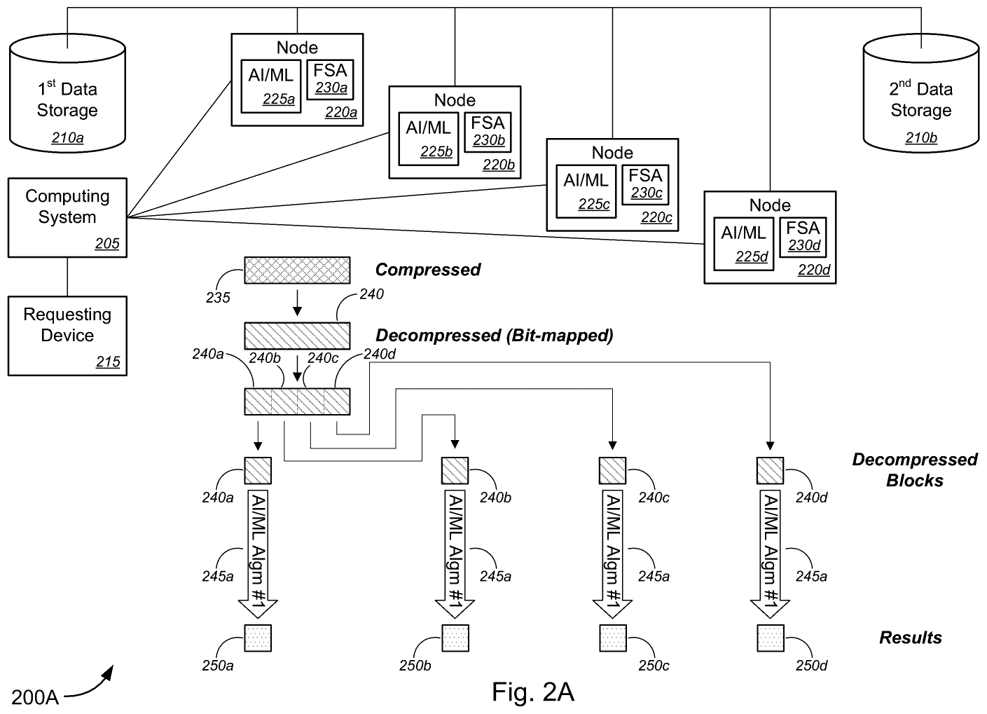

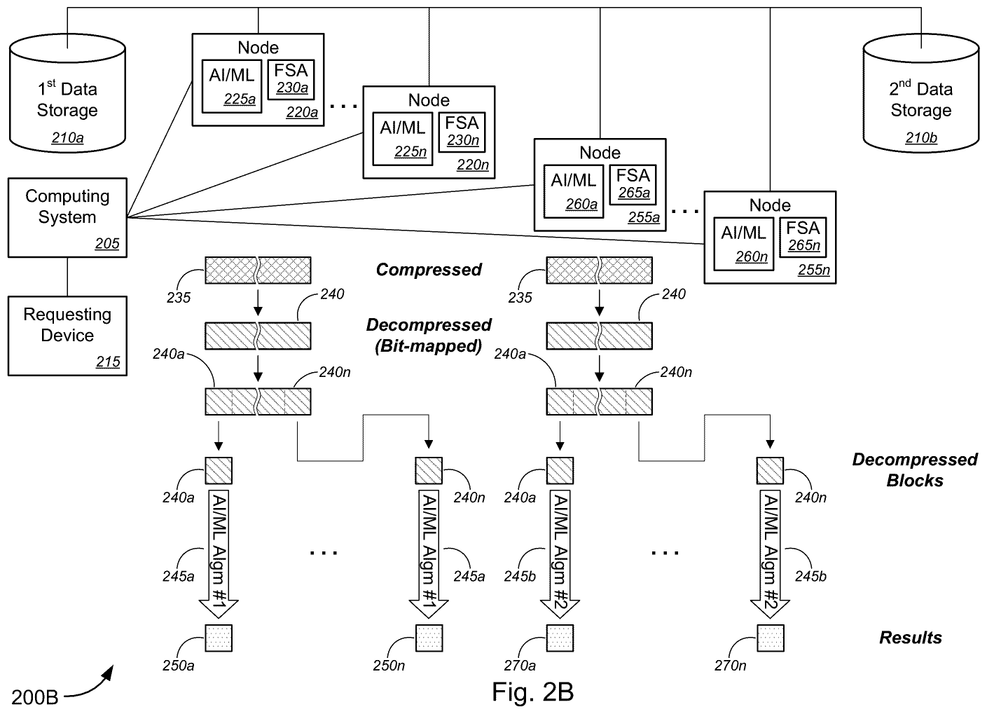

These and other functions of the system 100 (and its components) are described in greater detail below with respect to FIGS. 2-4.

FIGS. 2A and 2B (collectively, “FIG. 2”) are schematic diagrams illustrating a set of non-limiting examples 200A and 200B of a process flow for implementing block-level, bit-mapped binary data access for parallel processing, in accordance with various embodiments. FIG. 2A depicts decompression of data by one node and processing of assigned portions of the decompressed data by a plurality of nodes using one AI/ML algorithm, while FIG. 2B depicts decompression of data by two nodes and processing of assigned portions of the decompressed data by two pluralities of nodes each plurality using a different AI/ML algorithm.

In the non-limiting example 200A of FIG. 2A, computing system 205 may communicatively couple with a requesting device 215 and each of a plurality of nodes 220a-220d (collectively, “nodes 220” or “compute nodes 220” or the like). Each node 220 may communicatively couple with the computing system 205 and at least one of a first data storage device(s) 210a or a second data storage device(s) 210b, or the like. Each node 220 may include, but is not limited to, an AI/ML system 225 among AI/ML systems 225a-225d and an FSA 230 among FSAs 230a-230d, or the like.

In some embodiments, computing system 205, first data storage device(s) 210a, second data storage device(s) 210b, requesting device 215, nodes 220a-220d, AI/ML systems 225a-225d, and FSAs 230a-230d of example 200A of FIG. 2A may be similar, if not identical, to computing system 105a and/or 105b, a source of compressed data (including, but not limited to, one or more of computing system 105a or 105b, database(s) 110, file system server 150, database(s) 155, remote content source(s) 180, database(s) 185, multimedia database(s) 190, and/or cloud database(s) 195, or the like), a data storage location for decompressed data (including, but not limited to, one or more of FSAs 130a-130n and/or 145a-145n, file system server 150, and/or database(s) 155, or the like), requesting device 115a and/or 115b, nodes 120a-120n and/or 135a-135n, AI/ML systems 125a-125n and/or 140a-140n, and FSAs 130a-130n and/or 145a-145n, respectively, of system 100 of FIG. 1, and the description of these components of system 100 of FIG. 1 are similarly applicable to the corresponding components of FIG. 2A.

Referring to the non-limiting embodiment 200A of FIG. 2A, computing system 205 may receive, from requesting device 215, a request to perform one or more AI/ML tasks on first data. In response to receiving the request to perform the one or more AI/ML tasks on the first data, computing system 205 may identify a first plurality of compute nodes 220a-220d among a plurality of compute nodes that is available to concurrently perform (and capable of concurrently performing) the one or more AI/ML tasks on portions of the first data. In some cases, computing system 205 may identify or select a first compute node 220a among the first plurality of compute nodes 220a-220d to perform decompression of compressed first data 235. The computing system 205 may send, to the first compute node 220a, one or more first instructions to decompress the (entire) compressed first data 235 and to perform at least one first AI/ML task 245a among the one or more AI/ML tasks (e.g., using its AI/ML system 225a, or the like) on a portion 240a of the decompressed first data 240. In some examples, the computing system 205 may assign the portions of the decompressed first data 240 to each of the first plurality of compute nodes 220a-220d either (i) after identifying the first plurality of compute nodes 220a-220d or (ii) after identifying or selecting the first compute node 220a, and/or the like. In this example, computing system 205 may assign node 220a to perform at least one AI/ML task on portion 240a of decompressed first data 240, may assign node 220b to perform at least one AI/ML task on portion 240b of decompressed first data 240, may assign node 220c to perform at least one AI/ML task on portion 240c of decompressed first data 240, and may assign node 220d to perform at least one AI/ML task on portion 240d of decompressed first data 240.

The first compute node 220a may receive the one or more first instructions from the computing system 205. In response to receiving the one or more first instructions, the first compute node 220a may access the compressed first data 235 from the first data storage device(s) 210a (i.e., the source(s) of compressed data), may decompress the (entire) compressed first data 235, and may store (in some cases, using FSA 230a, or the like) the (entire) decompressed first data in first data storage location. In some instances, the first data storage location may include, but is not limited to, at least one of FSA 230a, FSAs 230a-230d, the second data storage device(s) 210b, and/or other data storage location (including, but not limited to, one of a data storage location of a local disk storage device, a data storage location of a file system server, a data storage location of FSA 230a, or a data storage location of each of one or more other compute nodes among the first plurality of compute nodes 220b-220d, and/or the like). In some cases, the first data storage device(s) 210a and the second data storage device(s) 210b may be the same data storage device(s). Alternatively, the first data storage device(s) 210a and the second data storage device(s) 210b may be separate data storage devices. In some cases, the first compute node 220a may send a message regarding the decompressed first data 240 being stored in the first data storage location. The first compute node 220a may subsequently perform at least one AI/ML task (by AI/ML 225a, using at least one first AI/ML algorithm and/or model 245a, or the like) on an assigned portion 240a of decompressed first data 240. The first compute node 220a may then send results 250a of the at least one AI/ML task that is performed on portion 240a of decompressed first data 240, in some cases, to computing system 205 and/or at least one of first or second data storage device(s) 210a or 210b, or the like.

In some instances, accessing the compressed first data 235 may include one of: (1) the first compute node 220a receiving the compressed first data 235 from the computing system 205, the compressed first data 235 being sent by the computing system 205 as one of (a) part of the one or more first instructions, (b) part of a separate message after sending the one or more first instructions, or (c) part of a reply message in response to a query by the first compute node 220a; (2) the first compute node 220a retrieving the compressed first data 235 from a data source including, but not limited to, at least one of a file system server, a multimedia database, a shared database, or a cloud database, and/or the like; (3) the first compute node 220a retrieving the compressed first data 235 from at least one other compute node among the first plurality of compute nodes 220a-220d; (4) the first compute node 220a accessing the compressed first data 235 from one of the data source or the at least one other compute node, via an application programming interface (“API”); or (5) the first compute node 220a accessing the compressed first data 235 from one of the data source or the at least one other compute node, via a remote procedure call (“RPC”); or the like.

In some examples, sending the message regarding the decompressed first data 240 being stored in the first data storage location may include one of: (i) the first compute node 220a sending, to the computing system 205, the message regarding the decompressed first data 240 being stored in the first data storage location; (ii) the first compute node 220a sending, to each of the one or more other compute nodes 220b-220d, the message regarding the decompressed first data 240 being stored in the first data storage location; or (iii) publishing, by the compute node, the message (e.g., in a publication/subscription (“pub/sub”) system, or the like) regarding the decompressed first data 240 being stored in the first data storage location; and/or the like.

The computing system 205 may receive, from each of the first compute node 220a, the message regarding the first data storage location in which the decompressed first data 240 is being stored. The computing system 205 may send, to each of one or more second compute nodes 220b-220d among the first plurality of compute nodes 220a-220d, one or more second instructions to perform to perform at least one first AI/ML task 245a among the one or more AI/ML tasks (e.g., using its AI/ML system 225, or the like) on an assigned portion 240b, 240c, or 240d of the decompressed first data 240. In some cases, the one or more second instructions may include third instructions regarding how to access the assigned portion of the decompressed first data 240.

Each of the one or more second nodes 220b-220d may receive the one or more second instructions from the computing system 205. Based on a determination that the one or more second instructions may include the third instructions, each compute node 220b, 220c, or 220d may retrieve the assigned portion 240b, 240c, or 240d, respectively, of the decompressed first data 240, based on the third instructions. In some instances, prior to retrieving the assigned portion of the decompressed first data, each compute node 220b, 220c, or 220d may calculate the start of the assigned portion of the first decompressed data, based on the third instructions and based on the calculated start of the assigned portion of the first decompressed data. In the case that the one or more second instructions do not include instructions regarding how to access the assigned portion of the decompressed first data 240, each compute node 220b, 220c, or 220d may retrieve the assigned portion 240b, 240c, or 240d, respectively, of the decompressed first data 240, in some cases, based on established or existing protocols or procedures of its FSA 230b, 230c, or 230d, or the like. In some examples, decompressing the compressed first data 235 may further include the first compute node 220a generating bit-mapped binary data, and each compute node 220b, 220c, or 220d retrieving the assigned portion 240b, 240c, or 240d, respectively, of the decompressed first data 240 may include accessing one or more blocks of the bit-mapped binary data corresponding to the assigned portion 240b, 240c, or 240d, respectively, of the decompressed first data 240.

Each compute node 220b, 220c, or 220d may subsequently perform at least one AI/ML task (by AI/ML 225b, 225c, or 225d, respectively, using at least one first AI/ML algorithm and/or model 245a, or the like) on an assigned portion 240b, 240c, or 240d, respectively, of decompressed first data 240. The first compute node 220a may then send results 250b, 250c, or 250d, respectively, of the at least one AI/ML task that is performed on portion 240b, 240c, or 240d, respectively, of decompressed first data 240, in some cases, to computing system 205 and/or at least one of first or second data storage device(s) 210a or 210b, or the like.

The computing system 205 may receive, from each of the first compute node 220a and from each of the one or more second compute nodes 220b-220d, results 250a-250d of one of the at least one AI/ML task, and may collate or compile the received results 250a-250d as results 250. The computing system 205 may then send the collated or compiled results 250 to the requesting device 215.

In the non-limiting example 200B of FIG. 2B, computing system 205 may communicatively couple with a requesting device 215 and each of a first plurality of nodes 220a-220n (collectively, “nodes 220” or “compute nodes 220” or the like) and a second plurality of nodes 255a-255n (collectively, “nodes 255” or “compute nodes 255” or the like). Each node 220 or 255 may communicatively couple with the computing system 205 and at least one of a first data storage device(s) 210a or a second data storage device(s) 210b, or the like. Each node 220 (or 255) may include, but is not limited to, an AI/ML system 225 (or 260) among AI/ML systems 225a-225n (or 260a-260n) and an FSA 230 (or 265) among FSAs 230a-230n (or 265a-265n), or the like.

In some embodiments, computing system 205, first data storage device(s) 210a, second data storage device(s) 210b, requesting device 215, nodes 220a-220n and/or 255a-255n, AI/ML systems 225a-225n and/or 260a-260n, and FSAs 230a-230n and/or 265a-265n of example 200B of FIG. 2B may be similar, if not identical, to computing system 105a and/or 105b, a source of compressed data (including, but not limited to, one or more of computing system 105a or 105b, database(s) 110, file system server 150, database(s) 155, remote content source(s) 180, database(s) 185, multimedia database(s) 190, and/or cloud database(s) 195, or the like), a data storage location for decompressed data (including, but not limited to, one or more of FSAs 130a-130n and/or 145a-145n, file system server 150, and/or database(s) 155, or the like), requesting device 115a and/or 115b, nodes 120a-120n and/or 135a-135n, AI/ML systems 125a-125n and/or 140a-140n, and FSAs 130a-130n and/or 145a-145n, respectively, of system 100 of FIG. 1, and the description of these components of system 100 of FIG. 1 are similarly applicable to the corresponding components of FIG. 2B.

Example 200B of FIG. 2B differs from example 200A of FIG. 2A in that: (1) computing system 205 may identify (and assign) the first plurality of compute nodes 220a-220n and the second plurality of compute nodes 255a-255n to perform the one or more AI/ML tasks on (portions of) the first data; (2) computing system 205 may identify or select compute nodes 220a and 255a to each perform decompression of compressed first data 235; and (3) computing system 205 may send, to compute node 220a, one or more first instructions to decompress the (entire) compressed first data 235 and to perform at least one first AI/ML task 245a among the one or more AI/ML tasks (e.g., using its AI/ML system 225a, or the like) on a portion 240a of the decompressed first data 240, and may (concurrently) send, to compute node 255a, one or more fourth instructions to decompress the (entire) compressed first data 235 and to perform at least one second AI/ML task 245b among the one or more AI/ML tasks (e.g., using its AI/ML system 260a, or the like) on the (same) portion 240a of the decompressed first data 240.

In addition to the computing system 205 receiving the message regarding the first data storage location in which the decompressed first data 240 is being stored by the compute node 220a, computing system 205 may receive a similar message from compute node 255a. Similar to the one or more second instructions that computing system 205 sends to compute nodes 220b-220n to perform at least one first AI/ML task 245a among the one or more AI/ML tasks (e.g., using its AI/ML system 225, or the like) on an assigned portion 240b-240n, respectively, of the decompressed first data 240, computing system 205 may send, to each of compute nodes 255b-255n, one or more fifth instructions to perform at least one second AI/ML task 245b among the one or more AI/ML tasks (e.g., using its AI/ML system 260, or the like) on an assigned portion 240b-240n, respectively, of the decompressed first data 240.

In addition to compute node 220a of example 200B performing the tasks of compute node 220a of example 200A and compute nodes 220b-220n of example 200B performing the tasks of compute nodes 220b-220d of example 200A, compute node 255a of example 200B would perform the tasks of compute node 220a of example 200B except performing the second AI/ML tasks 245b instead of the first AI/ML tasks 245a, on the same portion 240a of decompressed first data 240, to produce result 270a, and compute nodes 255b-255n of example 200B would perform the tasks of compute nodes 220b-220n of example 200B except performing the second AI/ML tasks 245b instead of the first AI/ML tasks 245a, on the same portions 240b-240n, respectively, of decompressed first data 240, to produce results 270b-270n, respectively.

In addition to computing system 205 receiving results 250a-250n from compute nodes 220a-220n, computing system 205 may receive results 270a-270n from compute nodes 255a-255n. The computing system 205 may collate or compile the received results 250a-250n as results 250 and the received results 270a-270n as results 270. The computing system 205 may then send the collated or compiled results 250 and 270 to the requesting device 215. Example 200B of FIG. 2B may otherwise be similar, if not identical, to example 200A of FIG. 2A.

These and other functions of the examples 200A and 200B (and their components), or alternatives thereof, are described in greater detail herein with respect to FIGS. 1, 3, and 4.

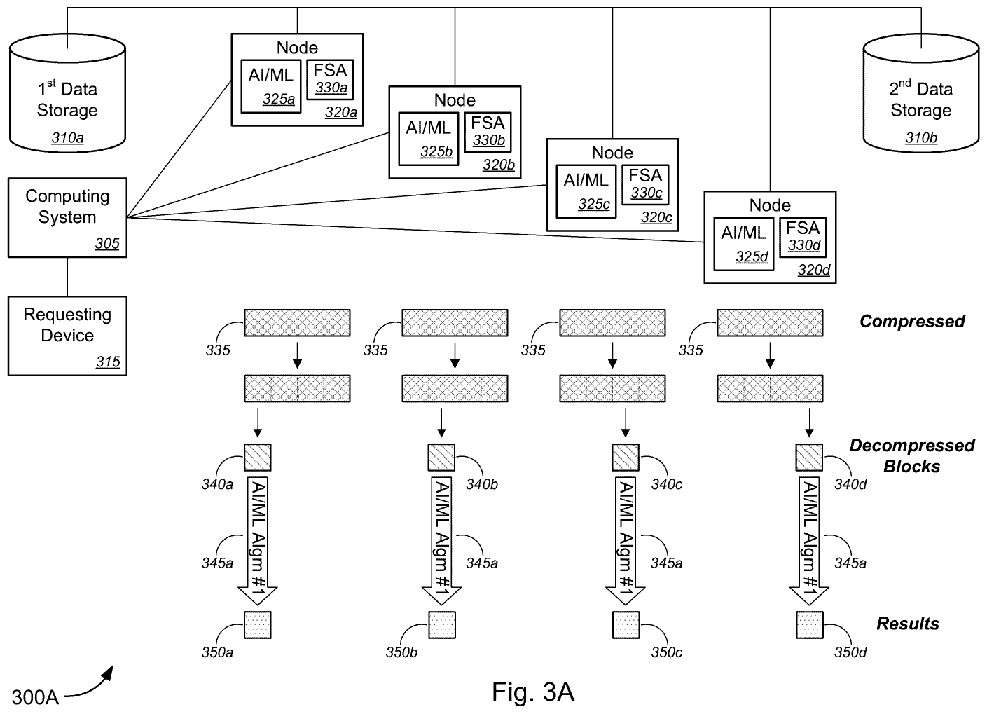

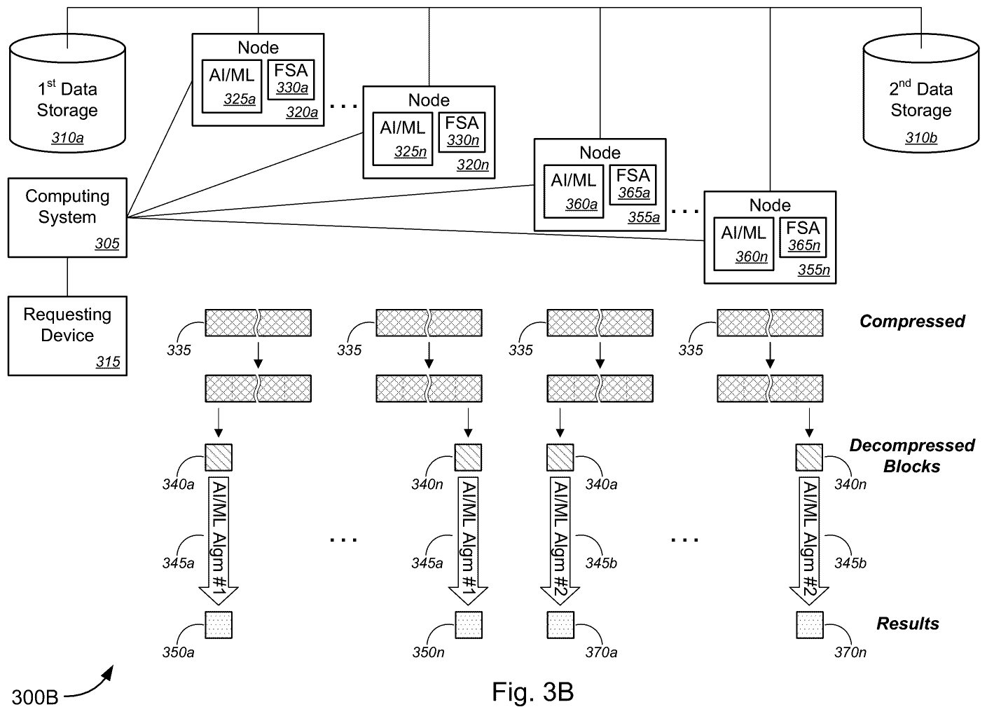

FIGS. 3A and 3B (collectively, “FIG. 3”) are schematic diagrams illustrating another set of non-limiting examples 300A and 300B of a process flow for implementing block-level, bit-mapped binary data access for parallel processing, in accordance with various embodiments. FIG. 3A depicts decompression of an assigned portion of data and processing of the decompressed assigned portions of the data (using one AI/ML algorithm) by each of a plurality of nodes, while FIG. 3B depicts decompression of an assigned portion of data and processing of the decompressed assigned portions of the data, using a first AI/ML algorithm by each of a first plurality of nodes and using a second AI/ML algorithm by each of a second plurality of nodes.

In the non-limiting example 300A of FIG. 3A, computing system 305 may communicatively couple with a requesting device 315 and each of a plurality of nodes 320a-320d (collectively, “nodes 320” or “compute nodes 320” or the like). Each node 320 may communicatively couple with the computing system 305 and at least one of a first data storage device(s) 310a or a second data storage device(s) 310b, or the like. Each node 320 may include, but is not limited to, an AI/ML system 325 among AI/ML systems 325a-325d and an FSA 330 among FSAs 330a-330d, or the like.

In some embodiments, computing system 305, first data storage device(s) 310a, second data storage device(s) 310b, requesting device 315, nodes 320a-320d, AI/ML systems 325a-325d, and FSAs 330a-330d of example 300A of FIG. 3A may be similar, if not identical, to computing system 105a and/or 105b, a source of compressed data (including, but not limited to, one or more of computing system 105a or 105b, database(s) 110, file system server 150, database(s) 155, remote content source(s) 180, database(s) 185, multimedia database(s) 190, and/or cloud database(s) 195, or the like), a data storage location for decompressed data (including, but not limited to, one or more of FSAs 130a-130n and/or 145a-145n, file system server 150, and/or database(s) 155, or the like), requesting device 115a and/or 115b, nodes 120a-120n and/or 135a-135n, AI/ML systems 125a-125n and/or 140a-140n, and FSAs 130a-130n and/or 145a-145n, respectively, of system 100 of FIG. 1, and the description of these components of system 100 of FIG. 1 are similarly applicable to the corresponding components of FIG. 3A.

Similarly, computing system 305, first data storage device(s) 310a, second data storage device(s) 310b, requesting device 315, nodes 320a-320d, AI/ML systems 325a-325d, FSAs 330a-330d, compressed first data 335, decompressed first data (or decompressed first data blocks) 340a-340d, at least one first AI/ML task 345a, and results 350a-350d of example 300A of FIG. 3A may be similar, if not identical, to computing system 205, first data storage device(s) 210a, second data storage device(s) 210b, requesting device 215, nodes 220a-220d, AI/ML systems 225a-225d, FSAs 230a-230d, compressed first data 235, decompressed first data (or decompressed first data blocks) 240a-240d, at least one first AI/ML task 245a, and results 250a-250d, respectively, of example 200A of FIG. 2A, and the description of these components of example 200A of FIG. 2A are similarly applicable to the corresponding components of example 300A of FIG. 3A.

Example 300A of FIG. 3A is similar to example 200A of FIG. 2A, except instead of computing system 205 instructing a single node (i.e., compute node 220a) to decompress—and the single node subsequently decompressing—the (entire) compressed first data 235, computing system 305 may instruct each of compute nodes 320a-320d (by sending one or more sixth instructions) to decompress—and each of compute nodes 320a-320d subsequently decompressing—a portion (i.e., an assigned portion) of compressed first data 335. At the same time, the computing system 305 may instruct each of compute nodes 320a-320d (by sending the one or more sixth instructions) to perform the at least one first AI/ML task 345a on the corresponding (assigned) portion 340a-340d of decompressed first data 340 to produce results 350a-350d.

In some examples, each compute node 320 (among the compute nodes 320a-320d) may receive a state of decompression from at least one of the computing system 305 or one other compute node among the compute nodes 320a-320d. In such cases, the one or more sixth instructions may be sent by the at least one of the computing system 305 or the one other compute node, respectively. Each compute node may decompress the assigned portion of the compressed first data 335, based on at least one of the state of decompression or the one or more sixth instructions. Each compute node may determine an updated state of decompression after decompressing the assigned portion of the compressed first data 335. Each compute node may send the updated state of decompression to at least one of the computing system 305 or one or more other compute nodes among the compute nodes 320a-320d. Each compute node may perform the at least one first AI/ML task 345a on the corresponding (assigned) portion 340a-340d of decompressed first data 340 to produce result 350 among results 350a-350d, and may send the result 350 to the computing system 305. Example 300A of FIG. 3A may otherwise be similar, if not identical, to example 200A of FIG. 2A.

In the non-limiting example 300B of FIG. 3B, computing system 305 may communicatively couple with a requesting device 315 and each of a first plurality of nodes 320a-320n (collectively, “nodes 320” or “compute nodes 320” or the like) and a second plurality of nodes 355a-355n (collectively, “nodes 355” or “compute nodes 355” or the like). Each node 320 or 355 may communicatively couple with the computing system 305 and at least one of a first data storage device(s) 310a or a second data storage device(s) 310b, or the like. Each node 320 (or 355) may include, but is not limited to, an AI/ML system 325 (or 360) among AI/ML systems 325a-325n (or 360a-360n) and an FSA 330 (or 365) among FSAs 330a-330n (or 365a-365n), or the like.

In some embodiments, computing system 305, first data storage device(s) 310a, second data storage device(s) 310b, requesting device 315, nodes 320a-320n and/or 355a-355n, AI/ML systems 325a-325n and/or 360a-360n, and FSAs 330a-330n and/or 365a-365n of example 300B of FIG. 3B may be similar, if not identical, to computing system 105a and/or 105b, a source of compressed data (including, but not limited to, one or more of computing system 105a or 105b, database(s) 110, file system server 150, database(s) 155, remote content source(s) 180, database(s) 185, multimedia database(s) 190, and/or cloud database(s) 195, or the like), a data storage location for decompressed data (including, but not limited to, one or more of FSAs 130a-130n and/or 145a-145n, file system server 150, and/or database(s) 155, or the like), requesting device 115a and/or 115b, nodes 120a-120n and/or 135a-135n, AI/ML systems 125a-125n and/or 140a-140n, and FSAs 130a-130n and/or 145a-145n, respectively, of system 100 of FIG. 1, and the description of these components of system 100 of FIG. 1 are similarly applicable to the corresponding components of FIG. 3B.

Similarly, computing system 305, first data storage device(s) 310a, second data storage device(s) 310b, requesting device 315, nodes 320a-320n and/or 355a-355n, AI/ML systems 325a-325n and/or 360a-360n, and FSAs 330a-330n and/or 365a-365n, compressed first data 335, decompressed first data (or decompressed first data blocks) 340a-340n, at least one first AI/ML task 345a, at least one second AI/ML task 345b, and results 350a-350n and 370a-370n of example 300B of FIG. 3B may be similar, if not identical, to computing system 205, first data storage device(s) 210a, second data storage device(s) 210b, requesting device 215, nodes 220a-220n and/or 255a-255n, AI/ML systems 225a-225n and/or 260a-260n, and FSAs 230a-230n and/or 265a-265n, compressed first data 235, decompressed first data (or decompressed first data blocks) 240a-240n, at least one first AI/ML task 245a, at least one second AI/ML task 245b, and results 250a-250n and 270a-270n, respectively, of example 200B of FIG. 2B, and the description of these components of example 200B of FIG. 2B are similarly applicable to the corresponding components of example 300B of FIG. 3B.

Example 300B of FIG. 3B is similar to example 200B of FIG. 2B, except instead of computing system 205 instructing a single node from each of two pluralities of compute nodes (i.e., compute node 220a from first plurality of compute nodes 220a-220n and compute node 255a from first plurality of compute nodes 255a-255n) to decompress—and the single nodes 220a and 255a each subsequently decompressing—the (entire) compressed first data 235, computing system 305 may instruct each of compute nodes 320a-320n and 355a-355n (by sending one or more seventh instructions and one or more eighth instructions, respectively) to decompress—and each of compute nodes 320a-320n and 355a-355n subsequently decompressing—a portion (i.e., an assigned portion) of compressed first data 335. At the same time, the computing system 305 may instruct each of compute nodes 320a-320n (by sending the one or more seventh instructions) to perform the at least one first AI/ML task 345a on the corresponding (assigned) portion 340a-340n of decompressed first data 340 to produce results 350a-350n, and may instruct each of compute nodes 355a-355n (by sending the one or more eighth instructions) to perform the at least one second AI/ML task 345b (which is different from the at least one first AI/ML task 345a) on the corresponding (assigned) portion 340a-340n of decompressed first data 340 to produce results 370a-370n. In this manner, two sets of compute nodes are instructed to decompress on an assigned block level the same compressed first data 335 and to perform two different AI/ML tasks 345a and 345b on the (same) decompressed blocks 340a-340n to produce two sets of results 350a-350n and 370a-370n.

In some examples, each compute node 320 (among the compute nodes 320a-320n) may receive a state of decompression from at least one of the computing system 305 or one other compute node among the compute nodes 320a-320n. In some cases, the one or more seventh instructions may be sent by the at least one of the computing system 305 directly or the computing system 305 via the one other compute node. Similarly, each compute node 355 (among the compute nodes 355a-355n) may receive a state of decompression from at least one of the computing system 305 or one other compute node among the compute nodes 355a-355n. In some cases, the one or more eighth instructions may be sent by the at least one of the computing system 305 directly or the computing system 305 via the one other compute node. Each compute node may decompress the assigned portion of the compressed first data 335, based on at least one of the state of decompression, the one or more seventh instructions, or the one or more eighth instructions. Each compute node may determine an updated state of decompression after decompressing the assigned portion of the compressed first data 335. Each compute node may send the updated state of decompression to at least one of the computing system 305 or one or more other compute nodes among the compute nodes 320a-320n or among the compute nodes 355a-355n (depending on which set of compute nodes the compute node is in). Each compute node among the first set of compute nodes 320a-320n may perform the at least one first AI/ML task 345a on the corresponding (assigned) portion 340a-340n of decompressed first data 340 to produce result 350 among results 350a-350n, and may send the result 350 to the computing system 305. Similarly, each compute node among the first set of compute nodes 355a-355n may perform the at least one second AI/ML task 345b on the corresponding (assigned) portion 340a-340n of decompressed first data 340 to produce result 370 among results 370a-370n, and may send the result 370 to the computing system 305. Example 300B of FIG. 3B may otherwise be similar, if not identical, to example 200B of FIG. 2B.

These and other functions of the examples 300A and 300B (and their components), or alternatives thereof, are described in greater detail herein with respect to FIGS. 1, 2, and 4.

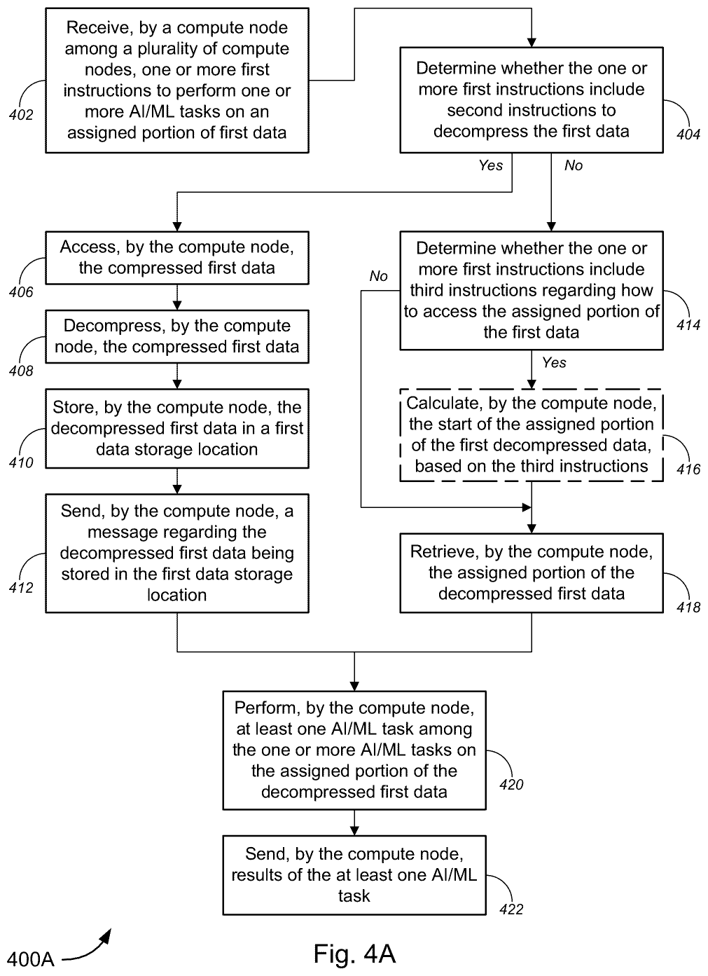

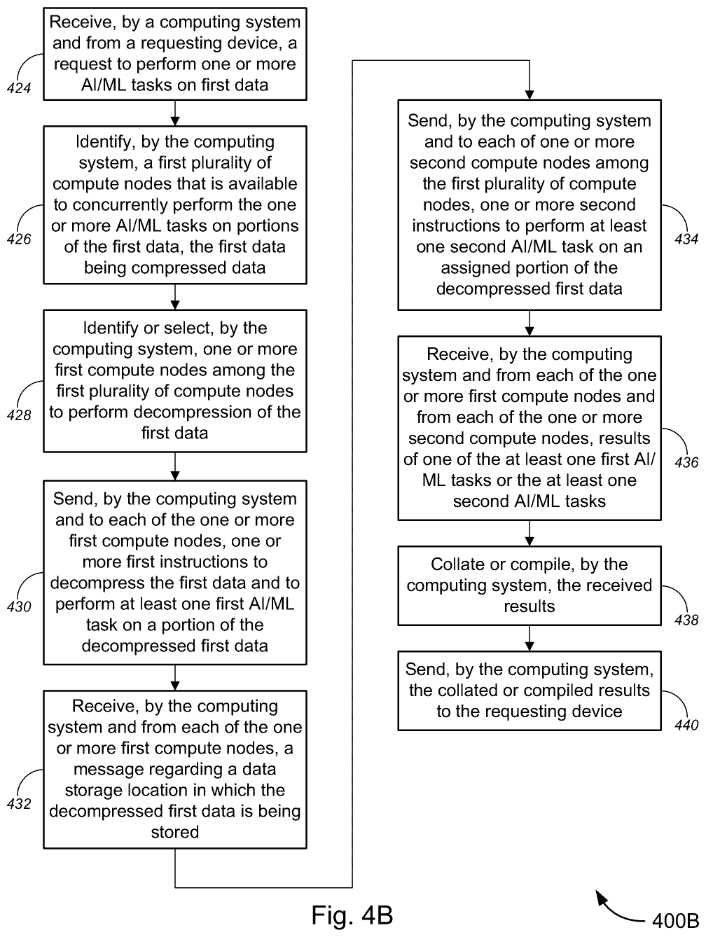

FIGS. 4A and 4B (collectively, “FIG. 4”) are flow diagrams illustrating various methods 400A and 400B for implementing block-level, bit-mapped binary data access for parallel processing, in accordance with various embodiments. FIG. 4A depicts method 400A from the perspective of a compute node among a plurality of compute nodes, while FIG. 4B depicts method 400B from the perspective of a computing system that orchestrates data access provisioning to the plurality of compute nodes for parallel processing by the plurality of compute nodes.

While the techniques and procedures are depicted and/or described in a certain order for purposes of illustration, it should be appreciated that certain procedures may be reordered and/or omitted within the scope of various embodiments. Moreover, while the method 400A or 400B illustrated by FIG. 4 can be implemented by or with (and, in some cases, are described below with respect to) the systems, examples, or embodiments 100, 200A, 200B, 300A, and 300B of FIGS. 1, 2A, 2B, 3A, and 3B, respectively (or components thereof), such methods may also be implemented using any suitable hardware (or software) implementation. Similarly, while each of the systems, examples, or embodiments 100, 200A, 200B, 300A, and 300B of FIGS. 1, 2A, 2B, 3A, and 3B, respectively (or components thereof), can operate according to the method 400A or 400B illustrated by FIG. 4 (e.g., by executing instructions embodied on a computer readable medium), the systems, examples, or embodiments 100, 200A, 200B, 300A, and 300B of FIGS. 1, 2A, 2B, 3A, and 3B can each also operate according to other modes of operation and/or perform other suitable procedures. Although method 400 of FIG. 4 is described with reference to performing AI/ML tasks, the various embodiments are not so limited, and method 400 may also be used to perform non-AI/ML tasks in addition or instead.

In the non-limiting embodiment of FIG. 4A, method 400A, at block 402, may include receiving, by a compute node among a plurality of compute nodes, one or more first instructions to perform one or more artificial intelligence (“AI”) and/or machine learning (“ML”) tasks on an assigned portion of first data. At block 404, method 400A may include determining, by the compute node, whether the one or more first instructions include second instructions to decompress the first data, the first data being compressed first data. Based on a determination that the one or more first instructions include second instructions to decompress the first data, method 400A may continue onto the process at block 406. Based on a determination that the one or more first instructions does not include instructions to decompress the first data, method 400A may continue onto the process at block 414.

Based on a determination that the one or more first instructions include second instructions to decompress the first data, method 400A may include accessing, by the compute node, the compressed first data (block 406); decompressing, by the compute node, the compressed first data (block 408); storing, by the compute node, the decompressed first data in a first data storage location (block 410); and sending, by the compute node, a message regarding the decompressed first data being stored in the first data storage location (block 412). Method 400A may continue onto the process at block 420.

Based on a determination that the one or more first instructions does not include instructions to decompress the first data, method 400A may include determining, by the compute node, whether the one or more first instructions include third instructions regarding how to access the assigned portion of the first data, the first data (in this case) being the decompressed first data. Based on a determination that the one or more first instructions include third instructions regarding how to access the assigned portion of the first data, method 400A may include, in the case that the third instructions further comprise instructions on how to calculate a start of the assigned portion of the first decompressed data, calculating, by the compute node, the start of the assigned portion of the first decompressed data, based on the third instructions (optional block 416); and retrieving, by the compute node, the assigned portion of the decompressed first data, based on the third instructions (and, where applicable, based on the calculated start of the assigned portion of the first decompressed data (block 418). Alternatively, based on a determination that the one or more first instructions does not include instructions regarding how to access the assigned portion of the first data, method 400A may include retrieving, by the compute node, the assigned portion of the decompressed first data (block 418), in some cases, based on established or existing protocols or procedures of its file system agent, or the like. Method 400A may continue onto the process at block 420.

At block 420, method 400A may comprise performing, by the compute node, at least one AI/ML task among the one or more AI/ML tasks on the assigned portion of the decompressed first data. Method 400A may further comprise, at block 422, sending, by the compute node, results of the at least one AI/ML task.

According to some embodiments, the first data may include, without limitation, one of a data file or streaming data, or the like. In some cases, the first data may be of a data type including, but not limited to, one of video data (e.g., video data in file formats including advanced video coding (“AVC”) (or H.264 or moving picture experts group-4 (“MPEG-4”)) format, high efficiency video coding (“HEVC”) (or H.265 or MPEG-H) format, audio video interleave (“AVI”) format, advanced systems format (“ASF”), etc.), two-dimensional (“2D”) image data (e.g., 2D image data in file formats including joint photographic experts group (“JPG”) format, graphics interchange format (“GIF”), portable network graphic (“PNG”) format, high efficiency image format (“HEIF”), etc.), three-dimensional (“3D”) image data (e.g., 3D image data in file formats including DWG format, STL format, OBJ format, 3D manufacturing format (“3MF”), etc.), animation data (e.g., animation data in file formats including GIF, PNG format, scalable vector graphics animation (“SVG”) format, etc.), gaming content data (e.g., gaming content data in file formats including PNG format, JPG format, GIF, SVG, etc.), or audio data (e.g., audio data in file formats including pulse-code modulation (“PCM”) format, waveform audio file (“WAV”) format, audio interchange file format (“AIFF”), MPEG-1 audio layer 3 (“MP3”) format, advanced audio coding (“ACC”) format, etc.), and/or the like.

In some embodiments, the one or more first instructions may be received from a computing system. In some examples, the computing system may include, but is not limited to, at least one of an orchestration system, a task distribution system, a task manager, a server, an AI system, a ML system, an AI/ML system, a deep learning (“DL”) system, a cloud computing system, or a distributed computing system, and/or the like.

In some instances, accessing the compressed first data (at block 406) may include one of: (1) receiving, by the compute node, the compressed first data from the computing system, the compressed first data being sent by the computing system as one of (a) part of the one or more first instructions, (b) part of a separate message after sending the one or more first instructions, or (c) part of a reply message in response to a query by the compute node; (2) retrieving, by the compute node, the compressed first data from a data source, where the data source may include at least one of a file system server, a multimedia database, a shared database, or a cloud database, and/or the like; (3) retrieving, by the compute node, the compressed first data from at least one other compute node among the plurality of compute nodes; (4) accessing, by the compute node, the compressed first data from one of the data source or the at least one other compute node, via an application programming interface (“API”); or (5) accessing, by the compute node, the compressed first data from one of the data source or the at least one other compute node, via a remote procedure call (“RPC”); or the like.

In some cases, decompressing the compressed first data (at block 408) may include one of: (A) decompressing, by the compute node, an entirety of the compressed first data; or (B) performing the following: (1) receiving, by the compute node, a state of decompression from at least one of the computing system or one other compute node among the plurality of compute nodes, the one or more first instructions being sent by the at least one of the computing system or the one other compute node; (2) decompressing, by the compute node, the assigned portion of the compressed first data, based on at least one of the state of decompression or the one or more first instructions; (3) determining, by the compute node, an updated state of decompression after decompressing the assigned portion of the compressed first data; and (4) sending, by the compute node, the updated state of decompression to at least one of the computing system or one or more other compute nodes among the plurality of compute nodes; or the like. In some examples, decompressing the compressed first data (at block 408) may further include generating, by the compute node, bit-mapped binary data, and retrieving the assigned portion of the decompressed first data may include accessing one or more blocks of the bit-mapped binary data corresponding to the assigned portion of the decompressed first data.

In some instances, storing the decompressed first data in the first data storage location (at block 410) may include storing, by a file system agent of the compute node, the decompressed first data in the first data storage location. In some cases, the first data storage location may include one of a data storage location of a local disk storage device, a data storage location of a file system server, a data storage location of the file system agent of the compute node, or a data storage location of each of one or more other compute nodes among the plurality of compute nodes, and/or the like.

In some examples, sending the message regarding the decompressed first data being stored in the first data storage location (at block 412) may include one of: (i) sending, by the compute node and to the computing system, the message regarding the decompressed first data being stored in the first data storage location; (ii) sending, by the compute node and to each of the one or more other compute nodes, the message regarding the decompressed first data being stored in the first data storage location; or (iii) publishing, by the compute node, the message (e.g., in a publication/subscription (“pub/sub”) system, or the like) regarding the decompressed first data being stored in the first data storage location; and/or the like.

According to some embodiments, retrieving the assigned portion of the decompressed first data may (at block 418) include one of: (1) retrieving, by a file system agent of the compute node, the assigned portion of the decompressed first data from a data storage location of a local disk storage device; (2) retrieving, by the file system agent of the compute node, the assigned portion of the decompressed first data from a data storage location of a file system server; or (3) retrieving, by the file system agent of the compute node, the assigned portion of the decompressed first data from a data storage location of the file system agent of the compute node; or the like. In some cases, retrieving the assigned portion of the decompressed first data (at block 418) may include retrieving, by the compute node, the assigned portion of the decompressed first data, without retrieving non-assigned portions of the decompressed first data, the non-assigned portions of the decompressed first data being assigned to one or more other compute nodes among the plurality of compute nodes.

In some embodiments, the one or more AI/ML tasks may include at least one of: (A) detecting or identifying an image of at least one object contained in the first data, using one or more AI/ML algorithms, the at least one object including, but not limited to, at least one of one or more people, one or more animals, one or more plants, one or more natural formations, one or more structures, one or more devices, one or more vehicles, or one or more constructs, and/or the like; (B) performing identity recognition or authentication of at least one person, based on biometric data of the at least one person contained in the first data, using one or more AI/ML algorithms; (C) analyzing or recognizing features of maps contained in the first data, using one or more AI/ML algorithms; (D) analyzing or recognizing features of satellite imagery contained in the first data, using one or more AI/ML algorithms; (E) analyzing or recognizing features of stellar imagery contained in the first data, using one or more AI/ML algorithms; (F) analyzing or decoding data contained in the first data, using one or more AI/ML algorithms; (G) performing pattern recognition, using one or more AI/ML algorithms; or (H) training one or more AI/ML algorithms; and/or the like. In some cases, the one or more AI/ML algorithms for performing each of these tasks may be the same for two or more of these tasks or, in some instances, may be the same for all of these tasks. In other cases, the one or more AI/ML algorithms may be different for each of these tasks.

In the non-limiting embodiment of FIG. 4B, method 400B, at block 424, may include receiving, by a computing system and from a requesting device, a request to perform one or more AI/ML tasks on first data. Method 400B may further include, at block 426, in response to receiving the request from the requesting device, identifying, by the computing system, a first plurality of compute nodes that is available to concurrently perform the one or more AI/ML tasks on portions of the first data, the first data being compressed data. Method 400B may further include identifying or selecting, by the computing system, one or more first compute nodes among the first plurality of compute nodes to perform decompression of the first data (block 428).

At block 430, method 400B may include sending, by the computing system and to each of the one or more first compute nodes, one or more first instructions to decompress the first data and to perform at least one first AI/ML task among the one or more AI/ML tasks on a portion of the decompressed first data. Method 400B, at block 432, receiving, by the computing system and from each of the one or more first compute nodes, a message regarding a data storage location in which the decompressed first data is being stored. Method 400B may further include, at block 434, sending, by the computing system and to each of one or more second compute nodes among the first plurality of compute nodes, one or more second instructions to perform at least one second AI/ML task among the one or more AI/ML tasks on an assigned portion of the decompressed first data, the one or more second instructions including third instructions regarding how to access the assigned portion of the decompressed first data. In some cases, the third instructions may further include instructions on how to calculate a start of the assigned portion of the first decompressed data. In some examples, the computing system may assign the portions of the decompressed first data to each of the one or more first compute nodes and the one or more second compute nodes cither (i) after identifying the first plurality of compute nodes (at block 426), (ii) after identifying or selecting the one or more first compute nodes (at block 428), or (iii) after receiving the message regarding the storage location in which the decompressed first data is being stored (at block 432), and/or the like.

Method 400B may further include receiving, by the computing system and from each of the one or more first compute nodes and from each of the one or more second compute nodes, results of one of the at least one first AI/ML tasks or the at least one second AI/ML tasks (block 436); collating or compiling, by the computing system, the received results (block 438); and sending, by the computing system, the collated or compiled results to the requesting device (block 440).

According to some embodiments, the decompressed first data may be divided among (and assigned to) a number of compute nodes including the one or more first compute nodes and the one or more second compute nodes. In some cases, the at least one second AI/ML tasks may be the same as the at least one first AI/ML tasks, and each of the number of compute nodes may perform the at least one first or second AI/ML tasks on its assigned portion of the decompressed first data.

In some examples, the one or more first compute nodes may include two or more compute nodes each providing the decompressed first data to one of two or more groups of compute nodes. In some instances, the one or more second compute nodes may be divided among (and assigned to) the two or more groups of compute nodes, and each group of compute nodes may perform at least one AI/ML tasks among the one or more AI/ML tasks that is different from AI/ML tasks performed by other groups of compute nodes.

In some embodiments, the one or more first instructions to decompress the first data may include one of: fourth instructions to decompress an entirety of the compressed first data; or fifth instructions to decompress the portion of the decompressed first data, based on a state of decompression from at least one of the computing system or one other compute node among the first plurality of compute nodes, and to send an updated state of decompression to at least one of the computing system or one or more other compute nodes among the plurality of compute nodes, after decompressing the portion of the compressed first data; or the like.

### Exemplary System and Hardware Implementation

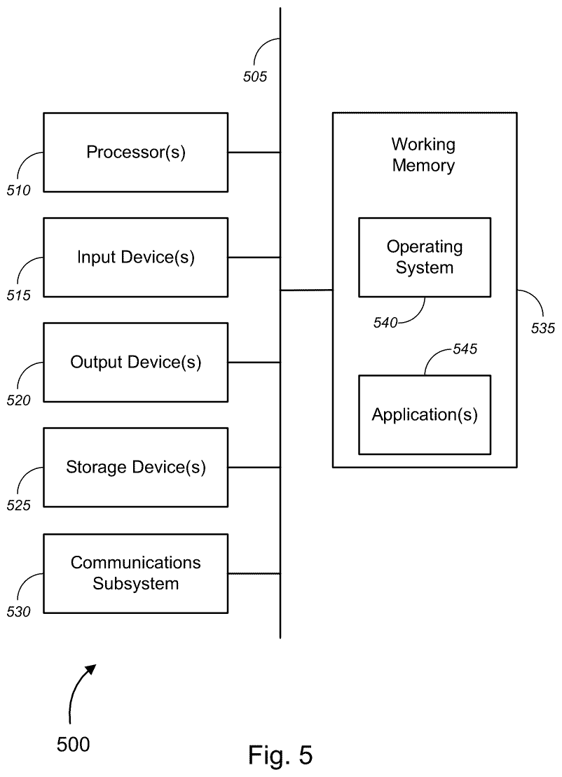

FIG. 5 is a block diagram illustrating an exemplary computer or system hardware architecture, in accordance with various embodiments. FIG. 5 provides a schematic illustration of one embodiment of a computer system 500 of the service provider system hardware that can perform the methods provided by various other embodiments, as described herein, and/or can perform the functions of computer or hardware system (i.e., computing systems 105a, 105b, 205, and 305, requesting devices 115a, 115b, 215, and 315, nodes 120a-120n, 135a-135n, 220a-220d, 220a-220n, 255a-255n, 320a-320d, 320a-320n, and 355a-355n, and file system server 150, etc.), as described above. It should be noted that FIG. 5 is meant only to provide a generalized illustration of various components, of which one or more (or none) of each may be utilized as appropriate. FIG. 5, therefore, broadly illustrates how individual system elements may be implemented in a relatively separated or relatively more integrated manner.

The computer or hardware system 500—which might represent an embodiment of the computer or hardware system (i.e., computing systems 105a, 105b, 205, and 305, requesting devices 115a, 115b, 215, and 315, nodes 120a-120n, 135a-135n, 220a-220d, 220a-220n, 255a-255n, 320a-320d, 320a-320n, and 355a-355n, and file system server 150, etc.), described above with respect to FIGS. 1-4—is shown comprising hardware elements that can be electrically coupled via a bus 505 (or may otherwise be in communication, as appropriate). The hardware elements may include one or more processors 510, including, without limitation, one or more general-purpose processors and/or one or more special-purpose processors (such as microprocessors, digital signal processing chips, graphics acceleration processors, and/or the like); one or more input devices 515, which can include, without limitation, a mouse, a keyboard, and/or the like; and one or more output devices 520, which can include, without limitation, a display device, a printer, and/or the like.

The computer or hardware system 500 may further include (and/or be in communication with) one or more storage devices 525, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including, without limitation, various file systems, database structures, and/or the like.

The computer or hardware system 500 might also include a communications subsystem 530, which can include, without limitation, a modem, a network card (wireless or wired), an infra-red communication device, a wireless communication device and/or chipset (such as a Bluetooth™ device, an 802.11 device, a Wi-Fi device, a WiMAX device, a wireless wide area network (“WWAN”) device, cellular communication facilities, etc.), and/or the like. The communications subsystem 530 may permit data to be exchanged with a network (such as the network described below, to name one example), with other computer or hardware systems, and/or with any other devices described herein. In many embodiments, the computer or hardware system 500 will further comprise a working memory 535, which can include a RAM or ROM device, as described above.

The computer or hardware system 500 also may comprise software elements, shown as being currently located within the working memory 535, including an operating system 540, device drivers, executable libraries, and/or other code, such as one or more application programs 545, which may comprise computer programs provided by various embodiments (including, without limitation, hypervisors, virtual machines (“VMs”), and the like), and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 525 described above. In some cases, the storage medium might be incorporated within a computer system, such as the system 500. In other embodiments, the storage medium might be separate from a computer system (i.e., a removable medium, such as a compact disc, etc.), and/or provided in an installation package, such that the storage medium can be used to program, configure, and/or adapt a general purpose computer with the instructions/code stored thereon. These instructions might take the form of executable code, which is executable by the computer or hardware system 500 and/or might take the form of source and/or installable code, which, upon compilation and/or installation on the computer or hardware system 500 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer or hardware system (such as the computer or hardware system 500) to perform methods in accordance with various embodiments of the invention. According to a set of embodiments, some or all of the procedures of such methods are performed by the computer or hardware system 500 in response to processor 510 executing one or more sequences of one or more instructions (which might be incorporated into the operating system 540 and/or other code, such as an application program 545) contained in the working memory 535. Such instructions may be read into the working memory 535 from another computer readable medium, such as one or more of the storage device(s) 525. Merely by way of example, execution of the sequences of instructions contained in the working memory 535 might cause the processor(s) 510 to perform one or more procedures of the methods described herein.

The terms “machine readable medium” and “computer readable medium,” as used herein, refer to any medium that participates in providing data that causes a machine to operate in a specific fashion. In an embodiment implemented using the computer or hardware system 500, various computer readable media might be involved in providing instructions/code to processor(s) 510 for execution and/or might be used to store and/or carry such instructions/code (e.g., as signals). In many implementations, a computer readable medium is a non-transitory, physical, and/or tangible storage medium. In some embodiments, a computer readable medium may take many forms, including, but not limited to, non-volatile media, volatile media, or the like. Non-volatile media includes, for example, optical and/or magnetic disks, such as the storage device(s) 525. Volatile media includes, without limitation, dynamic memory, such as the working memory 535. In some alternative embodiments, a computer readable medium may take the form of transmission media, which includes, without limitation, coaxial cables, copper wire, and fiber optics, including the wires that comprise the bus 505, as well as the various components of the communication subsystem 530 (and/or the media by which the communications subsystem 530 provides communication with other devices). In an alternative set of embodiments, transmission media can also take the form of waves (including without limitation radio, acoustic, and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer or hardware system 500. These signals, which might be in the form of electromagnetic signals, acoustic signals, optical signals, and/or the like, are all examples of carrier waves on which instructions can be encoded, in accordance with various embodiments of the invention.

The communications subsystem 530 (and/or components thereof) generally will receive the signals, and the bus 505 then might carry the signals (and/or the data, instructions, etc. carried by the signals) to the working memory 535, from which the processor(s) 505 retrieves and executes the instructions. The instructions received by the working memory 535 may optionally be stored on a storage device 525 either before or after execution by the processor(s) 510.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method, comprising:
receiving, by a compute node among a plurality of compute nodes, one or more first instructions to perform one or more tasks on an assigned portion of first data;
based on a determination that the one or more first instructions include second instructions to decompress the first data, the first data being compressed first data, performing the following:
accessing, by the compute node, the compressed first data;
decompressing, by the compute node, the compressed first data; and
storing, by the compute node, the decompressed first data in a first data storage location;
based on a determination that the one or more first instructions include third instructions regarding how to access the assigned portion of the first data, the first data being the decompressed first data, performing the following:
retrieving, by the compute node, the assigned portion of the decompressed first data, based on the third instructions;
performing, by the compute node, at least one task among the one or more tasks on the assigned portion of the decompressed first data; and
sending, by the compute node, results of the at least one task.

2. The method of claim 1, wherein the first data comprises one of a data file or streaming data, wherein the first data is of a data type comprising one of video data, two-dimensional (“2D”) image data, three-dimensional (“3D”) image data, animation data, gaming content data, or audio data.

3. The method of claim 1, wherein the one or more first instructions are received from a computing system, wherein the computing system comprises at least one of an orchestration system, a task distribution system, a task manager, a server, an artificial intelligence (“AI”) and/or machine learning (“ML”) system, a cloud computing system, or a distributed computing system.

4. The method of claim 3, wherein accessing the compressed first data comprises one of:
receiving, by the compute node, the compressed first data from the computing system, the compressed first data being sent by the computing system as one of part of the one or more first instructions, part of a separate message after sending the one or more first instructions, or part of a reply message in response to a query by the compute node;
retrieving, by the compute node, the compressed first data from a data source, wherein the data source comprises at least one of a file system server, a multimedia database, a shared database, or a cloud database;
retrieving, by the compute node, the compressed first data from at least one other compute node among the plurality of compute nodes;
accessing, by the compute node, the compressed first data from one of the data source or the at least one other compute node, via an application programming interface (“API”); or
accessing, by the compute node, the compressed first data from one of the data source or the at least one other compute node, via a remote procedure call (“RPC”).

5. The method of claim 3, wherein decompressing the compressed first data comprises one of:
decompressing, by the compute node, an entirety of the compressed first data; or
performing the following:
receiving, by the compute node, a state of decompression from at least one of the computing system or one other compute node among the plurality of compute nodes, the one or more first instructions being sent by the at least one of the computing system or the one other compute node;
decompressing, by the compute node, the assigned portion of the compressed first data, based on at least one of the state of decompression or the one or more first instructions;
determining, by the compute node, an updated state of decompression after decompressing the assigned portion of the compressed first data; and
sending, by the compute node, the updated state of decompression to at least one of the computing system or one or more other compute nodes among the plurality of compute nodes.

6. The method of claim 5, wherein decompressing the compressed first data further comprises generating, by the compute node, bit-mapped binary data, wherein retrieving the assigned portion of the decompressed first data comprises accessing one or more blocks of the bit-mapped binary data corresponding to the assigned portion of the decompressed first data.

7. The method of claim 3, wherein storing the decompressed first data in the first data storage location comprises:
storing, by a file system agent of the compute node, the decompressed first data in the first data storage location; and
sending, by the compute node, a message regarding the decompressed first data being stored in the first data storage location;
wherein the first data storage location comprises one of a data storage location of a local disk storage device, a data storage location of a file system server, a data storage location of the file system agent of the compute node, or a data storage location of each of one or more other compute nodes among the plurality of compute nodes.

8. The method of claim 7, wherein sending the message regarding the decompressed first data being stored in the first data storage location comprises one of:
sending, by the compute node and to the computing system, the message regarding the decompressed first data being stored in the first data storage location;
sending, by the compute node and to each of the one or more other compute nodes, the message regarding the decompressed first data being stored in the first data storage location; or
publishing, by the compute node, the message regarding the decompressed first data being stored in the first data storage location.

9. The method of claim 1, wherein retrieving the assigned portion of the decompressed first data comprises one of:
retrieving, by a file system agent of the compute node, the assigned portion of the decompressed first data from a data storage location of a local disk storage device;
retrieving, by the file system agent of the compute node, the assigned portion of the decompressed first data from a data storage location of a file system server; or
retrieving, by the file system agent of the compute node, the assigned portion of the decompressed first data from a data storage location of the file system agent of the compute node.

10. The method of claim 9, wherein the third instructions further comprise instructions on how to calculate a start of the assigned portion of the first decompressed data, wherein the method further comprises, prior to retrieving the assigned portion of the decompressed first data:
calculating, by the compute node, the start of the assigned portion of the first decompressed data, based on the third instructions.

11. The method of claim 9, wherein retrieving the assigned portion of the decompressed first data comprises retrieving, by the compute node, the assigned portion of the decompressed first data, without retrieving non-assigned portions of the decompressed first data, the non-assigned portions of the decompressed first data being assigned to one or more other compute nodes among the plurality of compute nodes.

12. The method of claim 1, wherein the one or more tasks comprise one or more artificial intelligence (“AI”) and/or machine learning (“ML”) tasks, and the one or more AI/ML tasks comprise at least one of:
detecting or identifying an image of at least one object contained in the first data, using one or more AI/ML algorithms, the at least one object comprising at least one of one or more people, one or more animals, one or more plants, one or more natural formations, one or more structures, one or more devices, one or more vehicles, or one or more constructs;
performing identity recognition or authentication of at least one person, based on biometric data of the at least one person contained in the first data, using one or more AI/ML algorithms;
analyzing or recognizing features of maps contained in the first data, using one or more AI/ML algorithms;
analyzing or recognizing features of satellite imagery contained in the first data, using one or more AI/ML algorithms;
analyzing or recognizing features of stellar imagery contained in the first data, using one or more AI/ML algorithms;
analyzing or decoding data contained in the first data, using one or more AI/ML algorithms;
performing pattern recognition, using one or more AI/ML algorithms; or
training one or more AI/ML algorithms.

13. A method, comprising:
in response to receiving, from a requesting device, a request to perform one or more tasks on first data, identifying, by a computing system, a first plurality of compute nodes that is available to concurrently perform the one or more tasks on portions of the first data, the first data being compressed data;
identifying or selecting, by the computing system, one or more first compute nodes among the first plurality of compute nodes to perform decompression of the first data;
sending, by the computing system and to each of the one or more first compute nodes, one or more first instructions to decompress the first data and to perform at least one first task among the one or more tasks on a portion of the decompressed first data;
receiving, by the computing system and from each of the one or more first compute nodes, a message regarding a data storage location in which the decompressed first data is being stored;
sending, by the computing system and to each of one or more second compute nodes among the first plurality of compute nodes, one or more second instructions to perform at least one second task among the one or more tasks on an assigned portion of the decompressed first data, the one or more second instructions including third instructions regarding how to access the assigned portion of the decompressed first data;
receiving, by the computing system and from each of the one or more first compute nodes and from each of the one or more second compute nodes, results of one of the at least one first tasks or the at least one second tasks;
collating or compiling, by the computing system, the received results; and
sending, by the computing system, the collated or compiled results to the requesting device.

14. The method of claim 13, wherein the computing system comprises at least one of an orchestration system, a task distribution system, a task manager, a server, an artificial intelligence (“AI”) and/or machine learning (“ML”) system, a cloud computing system, or a distributed computing system.

15. The method of claim 13, wherein the first data comprises one of a data file or streaming data, wherein the first data is of a data type comprising one of video data, two-dimensional (“2D”) image data, three-dimensional (“3D”) image data, animation data, gaming content data, or audio data.

16. The method of claim 13, wherein the decompressed first data is divided among a number of compute nodes comprising the one or more first compute nodes and the one or more second compute nodes, wherein the at least one second tasks are the same as the at least one first tasks, and each of the number of compute nodes performs the at least one first or second tasks on its assigned portion of the decompressed first data.

17. The method of claim 13, wherein the one or more first compute nodes comprise two or more compute nodes each providing the decompressed first data to one of two or more groups of compute nodes, wherein the one or more second compute nodes are divided among the two or more groups of compute nodes, wherein each group of compute nodes performs at least one tasks among the one or more tasks that is different from tasks performed by other groups of compute nodes.

18. The method of claim 13, wherein the one or more first instructions to decompress the first data comprises one of:
fourth instructions to decompress an entirety of the compressed first data; or
fifth instructions to decompress the portion of the decompressed first data, based on a state of decompression from at least one of the computing system or one other compute node among the first plurality of compute nodes, and to send an updated state of decompression to at least one of the computing system or one or more other compute nodes among the plurality of compute nodes, after decompressing the portion of the compressed first data.

19. The method of claim 13, wherein the third instructions further comprise instructions on how to calculate a start of the assigned portion of the first decompressed data.

20. A system, comprising:
a plurality of compute nodes; and
a computing system, comprising:
at least one first processor; and
a first non-transitory computer readable medium communicatively coupled to the at least one first processor, the first non-transitory computer readable medium having stored thereon computer software comprising a first set of instructions that, when executed by the at least one first processor, causes the computing system to:
in response to receiving, from a requesting device, a request to perform one or more artificial intelligence (“AI”) and/or machine learning (“ML”) tasks on first data, identify a first plurality of compute nodes among the plurality of compute nodes that is available to concurrently perform the one or more AI/ML tasks on portions of the first data, the first data being compressed data;
identify or select one or more first compute nodes among the first plurality of compute nodes to perform decompression of the first data;
send, to each of the one or more first compute nodes, one or more first instructions to decompress the first data and to perform at least one first AI/ML task among the one or more AI/ML tasks on a portion of the decompressed first data;
receive, from each of the one or more first compute nodes, a message regarding a data storage location in which the decompressed first data is being stored;
send, to each of one or more second compute nodes among the first plurality of compute nodes, one or more second instructions to perform at least one second AI/ML task among the one or more AI/ML tasks on an assigned portion of the decompressed first data, the one or more second instructions including third instructions regarding how to access the assigned portion of the decompressed first data;
receive, from each of the one or more first compute nodes and from each of the one or more second compute nodes, results of one of the at least one first AI/ML tasks or the at least one second AI/ML tasks;
collate or compile the received results; and
send the collated or compiled results to the requesting device.
